(19) United States
(12) Patent Application Publication
(10) Pub. No.: US 2024/0398019 A1
(43) Pub. Date: Dec. 5, 2024

(54) AEROSOL-GENERATING SYSTEM MOUTHPIECE WITH CONDENSATION MANAGEMENT

(71) Applicant: PHILIP MORRIS PRODUCTS S.A., Neuchatel (CH)

(72) Inventors: Rui Nuno Batista, Morges (CH); Ricardo Cali, Mannheim (DE); Cheng Peng, Hong Kong (CN)

(21) Appl. No.: 18/688,486

(22) PCT Filed: Aug. 30, 2022
(86) PCT No.: PCT/EP2022/074094

§ 371 Date: Mar. 1, 2024

(30) Foreign Application Priority Data
Sep. 1, 2021 (EP) 21194341.0

(51) Int. Cl. A24F 40/48; A24F 7/00; A24F 40/10; A24F 40/46; A24F 40/51; A24F 40/57; H05B 3/22

(52) U.S. Cl. CPC A24F 40/48; A24F 7/00; A24F 40/10; A24F 40/46; A24F 40/51; A24F 40/57; H05B 3/22

(57) ABSTRACT

The invention relates to an aerosol-generating system comprising a main unit (40) and a mouthpiece (10). The main unit comprises a main heating element (52) for heating an aerosol-forming substrate. The mouthpiece comprises an airflow path and an auxiliary heating element (12). The main heating element and the auxiliary heating element are configured to be separately controllable. The aerosol-generating system further comprises a temperature sensor and a controller (72) in electrical connection with the temperature sensor and the auxiliary heating element. The controller is configured to activate the auxiliary heating element in dependence of a temperature sensed by the temperature sensor. The invention further relates to a mouthpiece for an aerosol-generating system.

The present disclosure relates to an aerosol-generating system. The present disclosure further relates to a mouthpiece for an aerosol-generating system.

It is known to provide an aerosol-generating device for generating an inhalable vapor. Such systems may heat an aerosol-forming substrate to a temperature at which one or more components of the aerosol-forming substrate are volatilised without burning the aerosol-forming substrate. In aerosol-generating systems or devices a liquid aerosol-forming substrate may be delivered from a liquid storage portion to an electrical heating element. Upon heating to a target temperature, the aerosol-generating substrate vaporises to form an aerosol. The liquid substrate may be delivered to the heating element via a capillary component. The liquid storage portion may be formed as a replaceable or a refillable cartridge comprising a liquid aerosol-forming substrate. The cartridge may be attached to the aerosol-generating device for supplying the liquid aerosol-forming substrate to the device for aerosol generation.

Mouthpieces may become unpleasantly could when an aerosol-generating system is used by a user in cold environments. Further, aerosol generated by vaporizing the liquid aerosol-forming substrate may condense at a sidewall of the airflow path. This may be particularly pertinent in cold environments. Therefore, it would be desirable to provide a heater in the mouthpiece of an aerosol-generating device.

It would be desirable to provide an aerosol-generating system which may reduce condensation of vaporized aerosol-forming substrate in the airflow path downstream of the heater. It would be desirable to provide an aerosol-generating system which may guide back condensed aerosol droplets from a location downstream of the heater towards the heater. It would be desirable to provide an aerosol-generating system with a comfortably warm mouthpiece independent of an ambient temperature.

According to an embodiment of the invention there is provided an aerosol-generating system. The aerosol-generating system may comprise a main unit and a mouthpiece. The main unit may comprise a main heating element for heating an aerosol-forming substrate. The mouthpiece may comprise an airflow path and an auxiliary heating element.

According to an embodiment of the invention there is provided an aerosol-generating system comprising a main unit and a mouthpiece. The main unit comprises a main heating element for heating an aerosol-forming substrate. The mouthpiece comprises an airflow path and an auxiliary heating element.

By the provision of the auxiliary heating element of the mouthpiece, an aerosol-generating system which may reduce condensation of vaporized aerosol-forming substrate in the airflow path downstream of the heater may be provided. By the provision of the auxiliary heating element of the mouthpiece, an aerosol-generating system which may guide back condensed aerosol droplets from a location downstream of the heater towards the heater may be provided. By the provision of the auxiliary heating element of the mouthpiece, an aerosol-generating system with a comfortably warm mouthpiece independent of an ambient temperature may also be provided.

The mouthpiece may be replaceable. The replaceable mouthpiece may be a disposable item. The mouthpiece may be reusable.

The auxiliary heating element may be configured for heating at least a portion of the airflow path of the mouthpiece. The auxiliary heating element may be located within the airflow path of the mouthpiece. The mouthpiece may comprise an expansion chamber. The auxiliary heating element may be located the expansion chamber. The mouthpiece may comprise a homogenization chamber. The auxiliary heating element may be located the homogenization chamber.

The auxiliary heating element may be a resistive heating element.

The main heating element and the auxiliary heating element may be configured to be separately controllable.

The aerosol-generating system may comprise at least one temperature sensor. The aerosol-generating system may further comprise a controller in electrical connection with the temperature sensor and the auxiliary heating element. The controller may be configured to activate the auxiliary heating element in dependence of a temperature sensed by the temperature sensor.

The temperature sensor may be an ambient temperature sensor. The controller may be configured to activate or deactivate the auxiliary heating element in dependence of a temperature information received from the ambient temperature sensor. For example, in a cold environment, the controller may activate the auxiliary heating element. For example, in a warm environment, the controller may deactivate the auxiliary heating element.

The temperature sensor may be located in the airflow path of the mouthpiece. The controller may be configured to activate or deactivate the auxiliary heating element in dependence of a temperature information received from the temperature sensor located in the airflow path of the mouthpiece. For example, in a cold environment, cold ambient air may be drawn into the airflow path. The sensor may measure an undesirably cold airflow in the airflow path and the controller may activate the auxiliary heating element. When the sensor in the airflow path measures that the airflow in the airflow path is heated up to a desired temperature due to the action of the auxiliary heating element or due to a rising ambient temperature, the controller may turn off the auxiliary heating element.

The aerosol-generating system may comprise one or both of a main heating element temperature sensor for measuring the temperature of the main heating element, and an auxiliary heating element temperature sensor for measuring the temperature of the auxiliary heating element. The main heating element temperature sensor may be located at or near the main heating element. The main heating element temperature sensor may be configured to estimate the temperature of the main heating element based on a temperature dependent resistivity of the main heating element. The auxiliary heating element temperature sensor may be located at or near the auxiliary heating element. The auxiliary heating element temperature sensor may be configured to estimate the temperature of the main heating element based on a temperature dependent resistivity of the auxiliary heating element.

The controller may be configured to control a temperature profile of the main heating element based on the data derived by the main heating element temperature sensor. The controller may be configured to control a temperature profile of the auxiliary heating element based on the data derived by the auxiliary heating element temperature sensor.

The aerosol-generating system may comprise a controller in electrical connection with the auxiliary heating element, wherein the controller is in communication with an external data source. The controller may be configured to activate or deactivate the auxiliary heating element in dependence of a temperature information received from the external data source.

The mouthpiece may comprise a guiding member arranged in the airflow path of the mouthpiece. The guiding member may be configured to guide liquid components condensed from the airflow in a direction towards the main heating element.

A surface of the guiding member may comprise a hydrophobic material.

The guiding member may be cone-shaped. A tip of the cone-shaped guiding member may face in a direction towards the main heating element.

A longitudinal axis of the cone-shaped guiding member may be arranged in parallel to a longitudinal axis of the aerosol-generating system and the base of the cone-shaped guiding member may be directed towards a proximal end of the aerosol-generating system.

The cone-shaped guiding member may be hollow and may divide the airflow path of the mouthpiece into a downstream airflow chamber arranged within the hollow cone-shaped guiding member and an upstream airflow chamber surrounding the hollow cone-shaped guiding member.

The hollow cone-shaped guiding member may comprise one or more apertures arranged to fluidly connect the upstream airflow chamber and the downstream airflow chamber. The apertures may be irregularly arranged on the hollow cone-shaped guiding member. This may additionally improve turbulences of the airflow within the hollow cone-shaped guiding member.

The base (the widest part) of the hollow cone-shaped guiding member may comprise an aperture configured as an airflow outlet port.

The auxiliary heating element may be arranged within the upstream airflow chamber. The upstream airflow chamber may be a homogenization chamber. The downstream airflow chamber may be a homogenization chamber. Both the upstream and the downstream airflow chamber may be homogenization chambers.

The homogenization chamber may assist in the evolution of the aerosol after the initial event of vaporization. The homogenization chamber may assist in creating a turbulent airflow. A more homogenized distribution of the volatized particles in the aerosol may be achieved. More homogenized sizes of the volatized particles in the aerosol may be achieved.

The main unit may comprise a liquid storage portion for containing a liquid aerosol-forming substrate. The main heating element may be configured for heating the liquid aerosol-forming substrate.

The aerosol-generating system may comprise a cartridge for storing aerosol-forming substrate. The cartridge may comprise the liquid storage portion. The main unit may comprise a main body and a replaceable cartridge. The main body may comprise control electronics and a power supply. The main body may comprise the main heating element, or the cartridge may comprise the main heating element and the liquid storage portion. The mouthpiece may be releasably attached to the cartridge. The cartridge may be releasably attached to the main body.

The system may be a three-part system, wherein one end of the cartridge is releasably attachable to the main body and another end of the cartridge is releasably attachable to the mouthpiece. The system may be a three-part system, wherein the mouthpiece is releasably attachable to the main body and the cartridge is either releasably attachable to the main body or is releasably insertable into the main body.

The system may be a two-part system, wherein the cartridge and the mouthpiece form an integral part which is releasably attachable to the main body. The system may be a two-part system, wherein the main body and the cartridge form an integral part which is releasably attachable to the mouthpiece.

As used herein, the term ‘aerosol-forming substrate’ relates to a substrate capable of releasing one or more volatile compounds that can form an aerosol. Such volatile compounds may be released by heating the aerosol-forming substrate. An aerosol-forming substrate may conveniently be part of a cartridge. The cartridge may be configured to be replaceable or refillable.

The aerosol-forming substrate may be provided in a liquid form. The liquid aerosol-forming substrate may comprise an aerosol former such as propylene glycol or glycerine, and other additives and ingredients, such as flavourants. The liquid aerosol-forming substrate may comprise water, solvents, ethanol, plant extracts and natural or artificial flavours. The liquid aerosol-forming substrate may comprise alkaloids or cannabinoids. The liquid aerosol-forming substrate may comprise nicotine. The liquid aerosol-forming substrate may have a nicotine concentration of between about 0.5% and about 10%, for example about 2%. The liquid aerosol-forming substrate may be contained in a liquid storage portion of the aerosol-generating article, in which case the aerosol-generating article may be denoted as a cartridge. The aerosol-forming substrate may comprise an aerosol former that facilitates the formation of a dense and stable aerosol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Aerosol formers may be polyhydric alcohols or mixtures thereof, such as triethylene glycol, 1,3-butanediol and glycerine. The aerosol-former may be propylene glycol. The aerosol former may comprise both glycerine and propylene glycol.

As used herein, an ‘aerosol-generating system’ relates to a system comprising a main unit and a cartridge comprising an aerosol-forming substrate. The main unit may be an ‘aerosol-generating device’.

As used herein, an ‘aerosol-generating device’ relates to a device that interacts with an aerosol-forming substrate to generate an aerosol. The aerosol-forming substrate may be comprised in a cartridge. The aerosol-generating device may comprise a housing, electric circuitry, a power supply, a heating chamber and a heating element.

The electric circuitry may comprise a microprocessor, which may be a programmable microprocessor. The microprocessor may be part of a controller. The electric circuitry may comprise further electronic components. The electric circuitry may be configured to regulate a supply of power to the heater element.

Preferably, the main heating element is provided as a part of a vaporizing unit. The main heating element may be any device suitable for heating the liquid aerosol-forming substrate and vaporize at least a part of the liquid aerosol-forming substrate in order to form an aerosol.

The auxiliary heating element may be any device suitable for heating at least a portion of the mouthpiece.

One or both of the main heating element and the auxiliary heating element may exemplarily be a coil heater, a capillary tube heater, a mesh heater, a metal plate heater, or one or more electrically conductive tracks on an insulating substrate. The heater may exemplarily be a resistive heater which receives electrical power and transforms at least part of the received electrical power into heat energy. Alternatively, or in addition, one or both of the main heating element and the auxiliary heating element may be a susceptor that is inductively heated by a time varying magnetic field. One or both of the main heating element and the auxiliary heating element may comprise only a single heating element or a plurality of heating elements. The temperature of the heating element or elements is preferably controlled by electric circuitry.

In any of the embodiments described above, the at least one heating element preferably comprises an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese- and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required. Examples of suitable composite heater elements are disclosed in U.S. Pat. No. 5,498,855, WO-A-03/095688 and U.S. Pat. No. 5,514,630.

The vaporizing unit may further comprise a capillary material for transferring liquid aerosol-forming substrate to the heater element. The capillary material may have a fibrous or spongy structure. The capillary material preferably comprises a bundle of capillaries. For example, the capillary material may comprise a plurality of fibres or threads or other fine bore tubes. The fibres or threads may be generally aligned to convey liquid to the heater. Alternatively, the capillary material may comprise sponge-like or foam-like material. The structure of the capillary material forms a plurality of small pores or tubes, through which the liquid can be transported by capillary action. The capillary material may comprise any suitable material or combination of materials. Examples of suitable materials are porous material. Examples of suitable materials are sponge or foam material. Examples of suitable material include ceramic material. Examples of suitable material include graphite-based material. Suitable materials may be fibres. Suitable materials may be sintered powders. Suitable material may be foamed metal. Suitable material may be plastics material. Suitable material may fibrous material. Suitable material may be made of spun fibres. Suitable material may be made of extruded fibres. Suitable material may be made of cellulose acetate. Suitable material may be made of polyester. Suitable material may be made of bonded polyolefin. Suitable material may be made of polyethylene. Suitable material may be made of ethylene. Suitable material may be made of polypropylene. Suitable material may be made of nylon fibre. Suitable material may be made of ceramic. Suitable material may be made of combinations of one or more of ethylene, polyethylene, ethylene, polypropylene or nylon. The capillary material may have any suitable capillarity and porosity so as to be used with different liquid physical properties. The liquid has physical properties, including but not limited to viscosity, surface tension, density, thermal conductivity, boiling point and vapour pressure, which allow the liquid to be transported through the capillary material by capillary action. The capillary material may be configured to convey the aerosol-forming substrate to the vaporiser. The capillary material may extend into interstices in the vaporiser.

The one or more capillary wicks may be arranged to contact liquid held in the liquid storage portion. The one or more capillary wicks may extend into the liquid storage portion. In this case, in use, liquid may be transferred from the liquid storage portion to the one or more elements of the aerosol-generating means by capillary action in the one or more capillary wicks. The one or more capillary wicks may have a first end and a second end. The first end may extend into the liquid storage portion to draw liquid aerosol-forming substrate held in the liquid storage portion into the aerosol generating means.

Capillary material may be arranged to contact liquid held in the liquid storage portion. The capillary material may extend into the liquid storage portion. In this case, in use, liquid may be transferred from the liquid storage portion to the one or more elements of the aerosol-generating means by capillary action in the capillary material. The capillary material may have a first end and a second end. The first end may extend into the liquid storage portion to draw liquid aerosol-forming substrate held in the liquid storage portion into the aerosol generating means.

As used herein, the terms “upstream”, and “downstream”, are used to describe the relative positions of components, or portions of components, of the mouthpiece or an aerosol-generating device used together with the mouthpiece in relation to the direction in which air flows through the mouthpiece or aerosol-generating device during use thereof along the airflow path. The mouthpiece according to the invention may comprise a proximal end through which, in use, an aerosol exits the mouthpiece. The proximal end of the aerosol generating device may also be referred to as the mouth end or the downstream end. The proximal end of the aerosol generating device may be the mouthpiece connected to the aerosol generating device. The mouth end is downstream of the distal end. The distal end of the aerosol generating device or the mouthpiece may also be referred to as the upstream end. Components, or portions of components, of the mouthpiece or the aerosol generating device may be described as being upstream or downstream of one another based on their relative positions with respect to the airflow path through the mouthpiece or the aerosol generating device.

The term ‘airflow path’ as used herein denotes a channel suitable to transport gaseous media. An airflow path may be used to transport ambient air. An airflow path may be used to transport an aerosol. An airflow path may be used to transport a mixture of air and aerosol.

The cartridge for storing aerosol-forming substrate may be part of the replaceable mouthpiece. The cartridge may form an integral part of the mouthpiece. The cartridge may be refillable. When the aerosol-forming substrate is consumed, the user may refill the cartridge such that the mouthpiece including the refillable cartridge can be re-used. Designing parts to be re-usable helps to reduce waste and reduces the ecological impact of the device or the system or the cartridge on the environment.

The cartridge for storing aerosol-forming substrate may be part of the main unit of the aerosol-generating system. The cartridge may form an integral part of the main unit. The cartridge may be refillable. When the aerosol-forming substrate is consumed, the user may refill the cartridge such that the mouthpiece including the refillable cartridge can be re-used.

The cartridge for storing aerosol-forming substrate may be configured to be replaceable. When the aerosol-forming substrate is consumed, the user may remove the cartridge from the aerosol-generating system and may replace the used cartridge by a new filled cartridge.

Upon assembly of the aerosol-generating system, an airflow path may be defined between the mouthpiece and the main unit. The mouthpiece and the main unit may be connected using any suitable connection means. The connection means may include a screw connection, a friction fit or a form fit connection. The connection means may be configured such that the connection can be established by a user by hand. This may facilitate handling and assembly of the aerosol-generating system.

The mouthpiece and the main unit may have corresponding structural components with complementary geometrical shapes. The structural components with complementary geometrical shapes are preferably provided at adjacent interface portions of the mouthpiece and the main unit. Upon assembly of the mouthpiece and the main unit, these interface portions may be located next to each other. When the mouthpiece is connected to the main unit, these corresponding structural components of the mouthpiece and the main unit may define an airflow path from an air inlet to the air outlet via the main heating element and, optionally, via the auxiliary heating element. The airflow path may be formed upon assembly of the main unit and the mouthpiece. In those embodiments, without the mouthpiece, the main unit may be rendered inoperable, since no continuous airflow path for inhaling an aerosol is provided. Thereby, the main unit alone does not allow for formation of an aerosol suitable for inhalation. Thereby, an efficient protection mechanism against unauthorized use may be provided.

The cartridge and the mouthpiece may both be replaceable. One or both ends of the cartridge or the mouthpiece may be protected by a sealing foil. The sealing foil may be a pierceable sealing foil, which is ruptured during assembly of the aerosol-generating system. The sealing foil may be a removable sealing foil which is removed from the cartridge before it is assembled with the main device or main unit.

Such sealing foil may protect the cartridge and the mouthpiece during shipping and in particular before use from debris or other undesired contaminations.

According to an embodiment of the invention there is provided a mouthpiece for an aerosol-generating system as described herein.

Below, there is provided a non-exhaustive list of non-limiting examples. Any one or more of the features of these examples may be combined with any one or more features of another example, embodiment, or aspect described herein.

Example A: An aerosol-generating system comprising a main unit and a mouthpiece,
the main unit comprising
a main heating element for heating an aerosol-forming substrate;
the mouthpiece comprising
an airflow path and an auxiliary heating element.

Example B: The aerosol-generating system according to Example A, wherein the mouthpiece is replaceable.

Example C: The aerosol-generating system according to Example A or Example B, wherein the auxiliary heating element is configured for heating at least a portion of the airflow path of the mouthpiece, preferably, wherein the auxiliary heating element is located within the airflow path of the mouthpiece.

Example D: The aerosol-generating system according to any of the preceding examples, wherein the auxiliary heating element is a resistive heating element.

Example E: The aerosol-generating system according to any of the preceding examples, wherein the main heating element and the auxiliary heating element are configured to be separately controllable.

Example F: The aerosol-generating system according to any of the preceding examples, comprising
a temperature sensor; and
a controller in electrical connection with the temperature sensor and the auxiliary heating element,
wherein the controller is configured to activate the auxiliary heating element in dependence of a temperature sensed by the temperature sensor.

Example G: The aerosol-generating system according to Example F, wherein the temperature sensor is an ambient temperature sensor.

Example H: The aerosol-generating system according to Example F or Example G, wherein the temperature sensor is located in the airflow path of the mouthpiece.

Example I: The aerosol-generating system according to any of Examples A to E, comprising a controller in electrical connection with the auxiliary heating element, wherein the controller is in communication with an external data source, and wherein the controller is configured to activate the auxiliary heating element in dependence of a temperature information received from the external data source.

Example J: The aerosol-generating system according to any of the preceding examples, wherein the mouthpiece comprises a guiding member arranged in the airflow path of the mouthpiece, wherein the guiding member is configured to guide liquid components condensed from the airflow in a direction towards the main heating element.

Example K: The aerosol-generating system according to Example J, wherein a surface of the guiding member comprises a hydrophobic material.

Example L: The aerosol-generating system according to Example J or Example K, wherein the guiding member is cone-shaped, and wherein a tip of the cone-shaped guiding member faces in a direction towards the main heating element.

Example M: The aerosol-generating system according to any of Examples J to L, wherein a longitudinal axis of the cone-shaped guiding member is arranged in parallel to a longitudinal axis of the aerosol-generating system, and wherein a base of the cone-shaped guiding member is directed towards a proximal end of the aerosol-generating system.

Example N: The aerosol-generating system according to Example M, wherein the cone-shaped guiding member is hollow and divides the airflow path of the mouthpiece into a downstream airflow chamber arranged within the hollow cone-shaped guiding member and an upstream airflow chamber surrounding the hollow cone-shaped guiding member.

Example O: The aerosol-generating system according to Example N, wherein the hollow cone-shaped guiding member comprises one or more apertures arranged to fluidly connect the upstream airflow chamber and the downstream airflow chamber.

Example P: The aerosol-generating system according to Example N or Example O, wherein the base of the hollow cone-shaped guiding member comprises an aperture configured as an airflow outlet port.

Example Q: The aerosol-generating system according to any of Examples N to P, wherein the auxiliary heating element is arranged within the upstream airflow chamber.

Example R: The aerosol-generating system according to any of the preceding examples, wherein the main unit comprises a liquid storage portion comprising a liquid aerosol-forming substrate, and wherein the main heating element is configured for heating the liquid aerosol-forming substrate.

Example S: The aerosol-generating system according to Example R, wherein the main unit comprises a main body and a replaceable cartridge, the main body comprising control electronics and a power supply; and the cartridge comprising the main heating element and the liquid storage portion; wherein the mouthpiece is attached to the cartridge and wherein the cartridge is attached to the main body.

Example T: A mouthpiece for an aerosol-generating system according to any of the preceding examples.

Example U: The mouthpiece according to Example T, wherein the mouthpiece is replaceable.

Features described in relation to one embodiment may equally be applied to other embodiments of the invention.

The invention will be further described, by way of example only, with reference to the accompanying drawings in which:

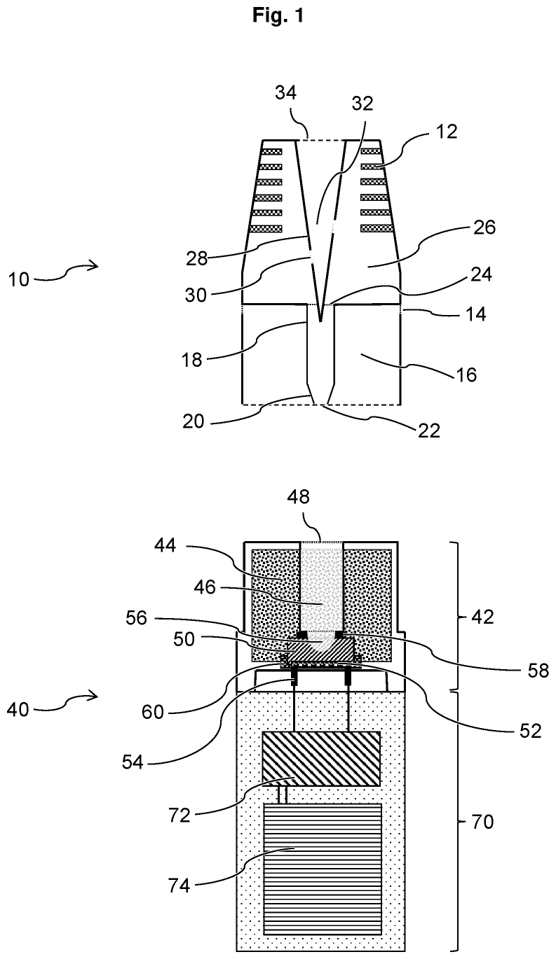

FIG. 1 shows an aerosol-generating system in detached configuration;

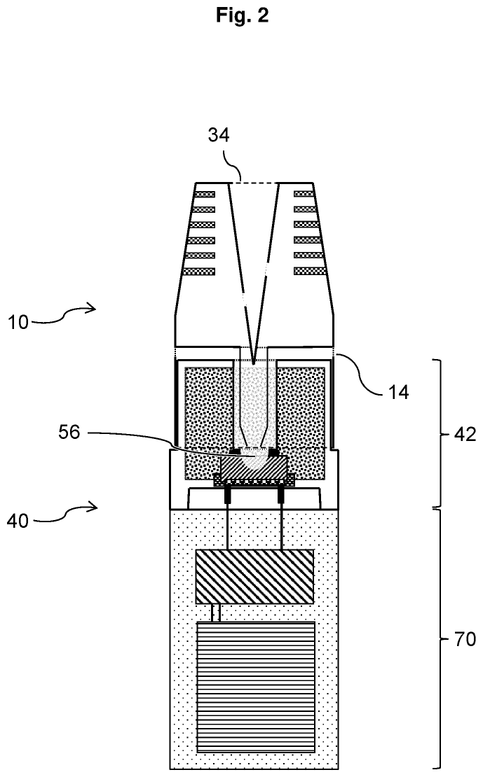

FIG. 2 shows an assembled aerosol-generating system; and

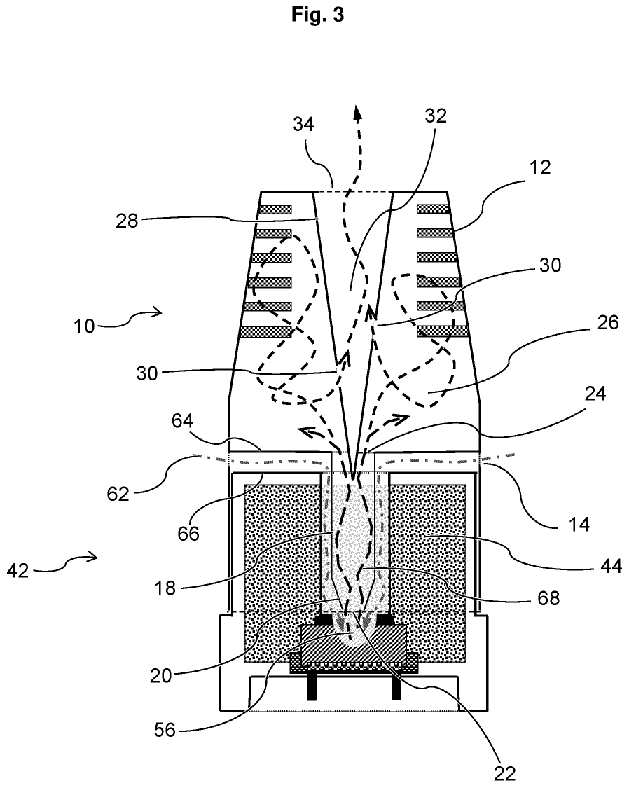

FIG. 3 shows a portion of an assembled aerosol-generating system.

FIG. 1 shows a cross-section of a generally cylindrically shaped aerosol-generating system comprising a replaceable mouthpiece 10 and a main unit 40 in a detached configuration.

The replaceable mouthpiece 10 comprises an auxiliary heating element 12. The auxiliary heating element 12 may be a resistive heating element, for example a coil of wire, or an arrangement of electrically conductive tracks on an insulating substrate. The replaceable mouthpiece 10 comprises air inlets 14 and an open chamber part 16. The replaceable mouthpiece 10 comprises a hollow element. In the embodiment shown, the hollow element is a hollow tubular element 18. However, the hollow element may as well be of a different shape, for example a hollow truncated cone or a hollow cuboid, as long as the airflow route (as described below) will not be blocked. The hollow tubular element 18 comprises a conical end portion 20, a tube inlet opening 22, and a tube outlet opening 24. The tube outlet opening 24 is in direct fluid connection with an annular homogenization chamber 26. The auxiliary heating element 12 is located within the homogenization chamber 26.

The mouthpiece 10 further comprises a cone-shaped guiding member 28 with apertures 30. A longitudinal axis of the cone-shaped guiding member 28 is arranged in parallel to a longitudinal axis of the aerosol-generating system. A base of the cone-shaped guiding member 28 is directed towards a proximal end of the aerosol-generating system. The cone-shaped guiding member 28 is hollow circumscribing an empty interior space 32.

The hollow cone-shaped guiding member 28 thus divides the airflow path of the mouthpiece 10 into a downstream airflow chamber arranged within the hollow cone-shaped guiding member 28 and an upstream airflow chamber surrounding the hollow cone-shaped guiding member 28, wherein the interior space 32 of the hollow cone-shaped member 28 is the downstream airflow chamber, and wherein the homogenization chamber 26 is the upstream airflow chamber.

The homogenization chamber 26 is in fluid connection with the interior space 32 of the hollow cone-shaped member 28 via the apertures 30. The base of the cone-shaped member 28 forms an air outlet 34 for inhalation by a user.

As can be seen from the upper part of FIG. 1, no continuous airflow path is defined in the mouthpiece 10 between the air inlet openings 14 and the outlet end 34. This is due to the open distal end of the mouthpiece 10 (see the dotted line at the bottom end of the mouthpiece 10 in FIG. 1) which does not provide an enclosed air channel from the air inlets 14 to the inside of the hollow tubular element 18.

The main unit 40 is an aerosol-generating device comprising a cartridge-and-heating section 42 and a power-and-control section 70. The cartridge-and-heating section 42 and the power-and-control section 70 may be detachable or may be formed as an integral main unit 40.

The cartridge-and-heating section 42 comprises a liquid storage portion 44 filled with a liquid aerosol-forming substrate. The liquid storage portion 44 coaxially surrounds a tubular cavity 46 with an open proximal end 48. The inner diameter of the tubular cavity 46 is larger than the outer diameter of the tubular element 18 of the mouthpiece 10.

The cartridge-and-heating section 42 comprises the main heating element for heating an aerosol-forming substrate. The main heating element comprises a ceramic heater main body 50 in connection to an electrical resistance 52 and electrical contacts 54. The ceramic heater main body 50 is a porous ceramic component that is in fluid communication with the liquid aerosol-forming substrate stored in the liquid storage portion 44. An aerosolization zone 56 is provided in a bowl-shaped cavity which is surrounded by the ceramic heater main body 50. Further, provided are overmolded sealings 58, 60 for mounting the main heating element in a leak-tight manner.

The power-and-control section 70 comprises a controller 72 and a battery 74. The controller 72 is in electrical connection to both the contacts 54 of the main heating element and the battery 74. Additional contacts (not shown) are provided to electrically connect the controller 72 to the auxiliary heating element 12 when the mouthpiece 10 is attached to the main unit 40.

When the main heating element is activated, liquid aerosol-forming substrate absorbed in the porous ceramic component 50 is evaporated. The evaporated aerosol-forming substrate is mixed with ambient air to form an aerosol. For this purpose, an airflow path is defined within the assembled aerosol-generating system.

FIG. 2 shows a cross-section of the aerosol-generating system of FIG. 1 in an assembled configuration where the replaceable mouthpiece 10 is attached to the main unit 40.

In the assembled configuration, the mouthpiece 10 is sleeved around and frictionally engaged with the cartridge-and-heating section 42 of the main unit 40. In the fully assembled position, an enclosed airflow path is defined between the corresponding structural components of the mouthpiece 10 and the cartridge-and-heating section 42 of the main unit 40 having complementary geometrical shapes. The airflow path extends from the air inlets 14 to the aerosolization zone 56 of the main heating element, and further from the aerosolization zone 56 to the air outlet 34.

When a user draws a puff at the outlet end 34 of the mouthpiece 10, an airflow is established from the air inlet openings 14 towards the aerosolization zone 56 where drawn air is mixed with an atomized aerosol-forming substrate. Under aerosol formation, the mixture is transported to the air outlet 34 where it is inhaled by a user. The airflow path is shown in more detail in FIG. 3.

FIG. 3 shows a cross-section of a portion of the aerosol-generating system of FIG. 2 in an assembled configuration, where the replaceable mouthpiece 10 is attached to the cartridge-and-heating section 42 of the main unit 40.

When a user draws a puff at the air outlet 34 of the mouthpiece 10, an airflow is established. Ambient air 62 enters the air inlets 14 into a first portion of the airflow path formed between walls 64 of the mouthpiece 10 and walls 66 of the cartridge-and-heating section 42. The air 62 further travels along a second portion of the airflow path formed between walls 18, 20 of the mouthpiece 10 and walls of the liquid storage portion 44 towards the aerosolization zone 56. The drawn air is mixed at the aerosolization zone 56 with the atomized aerosol-forming substrate such that an aerosol 68 is formed. The aerosol 68 is transported through tube inlet opening 22 into the hollow tubular element 18 with its conical end portion 20. The aerosol 68 further travels into the annular homogenization chamber 26. The annular homogenization chamber 26 provides for a turbulent airflow creating good conditions for homogenization of the aerosol 68.

Then, the mixture 68 enters apertures 30 into interior space 32 of the cone-shaped guiding member 28 to finally exit the mouthpiece 10 via air outlet 34 to be inhaled by a user. The apertures 30 are asymmetrically, or irregularly, disposed to additionally increase turbulence and homogenization within interior space 32.

When the aerosol generating system is used in an environment at room temperature, i.e. at around 20 degrees Celsius, there may be little tendency for unwanted excessive condensation of the aerosol 68 and droplet formation within the homogenization chamber 26.

However, in cold environments, for example outdoors in winter, where temperatures may be around zero degrees Celsius, unwanted excessive condensation of the aerosol 68 and droplet formation within the homogenization chamber 26 may be an issue.

To compensate for these cold temperatures, the auxiliary heating element 12 may be activated. Thereby, the temperature in the homogenization chamber 26 may be raised to reduce or prevent unwanted excessive condensation of the aerosol 68 and droplet formation.

In addition, the cone-shape of the guiding member 28 may assist in guiding condensed droplets which have been formed within the homogenization chamber 26 back towards the main heating element where the droplets may be heated to vaporize. This effect may be additionally enhanced when the outer surface of the cone-shaped guiding member 28 comprises a hydrophobic material.

Finally, auxiliary heating element 12 may also warm up the outer walls of the mouthpiece 10 to provide a pleasant feeling for a user contacting the mouthpiece with the lips, especially, when using the aerosol-generating system in cold environments.

1. An aerosol-generating system comprising a main unit and a mouthpiece,
the main unit comprising
a main heating element for heating an aerosol-forming substrate;
the mouthpiece comprising
an airflow path and an auxiliary heating element,
wherein the main heating element and the auxiliary heating element are configured to be separately controllable, and wherein the aerosol-generating system further comprises
a temperature sensor; and
a controller in electrical connection with the temperature sensor and the auxiliary heating element,
wherein the controller is configured to activate the auxiliary heating element in dependence of a temperature sensed by the temperature sensor, and
wherein the temperature sensor is an ambient temperature sensor.

2. The aerosol-generating system according to claim 1, wherein the mouthpiece is replaceable.

3. The aerosol-generating system according to claim 1, wherein the auxiliary heating element is configured for heating at least a portion of the airflow path of the mouthpiece, preferably, wherein the auxiliary heating element is located within the airflow path of the mouthpiece.

4. The aerosol-generating system according to claim 1, wherein the auxiliary heating element is a resistive heating element.

5. (canceled)

6. The aerosol-generating system according to claim 1, wherein the mouthpiece comprises a guiding member arranged in the airflow path of the mouthpiece, wherein the guiding member is configured to guide liquid components condensed from the airflow in a direction towards the main heating element

7. The aerosol-generating system according to claim 6, wherein a surface of the guiding member comprises a hydrophobic material.

8. The aerosol-generating system according to claim 5, wherein the guiding member is cone-shaped, and wherein a tip of the cone-shaped guiding member faces in a direction towards the main heating element.

9. The aerosol-generating system according to claim 5, wherein the guiding member is cone-shaped, wherein a longitudinal axis of the cone-shaped guiding member is arranged in parallel to a longitudinal axis of the aerosol-generating system, wherein a base of the cone-shaped guiding member is directed towards a proximal end of the aerosol-generating system, and wherein the cone-shaped guiding member is hollow and divides the airflow path of the mouthpiece into a downstream airflow chamber arranged within the hollow cone-shaped guiding member and an upstream airflow chamber surrounding the hollow cone-shaped guiding member.

10. The aerosol-generating system according to claim 7, wherein the hollow cone-shaped guiding member comprises one or more apertures arranged to fluidly connect the upstream airflow chamber and the downstream airflow chamber.

11. The aerosol-generating system according to claim 8, wherein the base of the hollow cone-shaped guiding member comprises an aperture configured as an airflow outlet port.

12. The aerosol-generating system according to claim 8, wherein the auxiliary heating element is arranged within the upstream airflow chamber.

13. The aerosol-generating system according to claim 1, wherein the main unit comprises a liquid storage portion comprising a liquid aerosol-forming substrate, and wherein the main heating element is configured for heating the liquid aerosol-forming substrate.

14. A mouthpiece for an aerosol-generating system according to claim 1.
